(19) United States
(12) Patent Application Publication
(10) Pub. No.: US 2015/0271038 A1
(43) Pub. Date: Sep. 24, 2015

(54) LINK-DEVICE SELECTING APPARATUS AND METHOD

(71) Applicant: FUJITSU LIMITED, Kawasaki-shi (JP)

(72) Inventors: Katsushi Miura, Atsugi (JP); Yoshiro Hada, Atsugishi (JP)

(21) Appl. No.: 14/621,103

(22) Filed: Feb. 12, 2015

(30) Foreign Application Priority Data
Mar. 20, 2014 (JP) 2014-058949

(51) Int. Cl. H04L 12/26

(52) U.S. Cl. CPC H04L 43/0811

(57) ABSTRACT

A link-device selecting apparatus includes an evaluation value calculating unit and a selecting unit. The evaluation value calculating unit calculates evaluation values of a plurality of second devices using first information, second information, and importance levels. First information is information on the position and orientation of an operator of a first device. Second information is information on the positions and orientations of the plurality of second devices. The importance levels include an importance level of the position of a second device and an importance level of the orientation of the second device, both given in accordance with a function of the second device. The selecting unit selects a device to be linked to the first device from the plurality of second devices using the evaluation values.

### CROSS-REFERENCE TO RELATED APPLICATION

This application is based upon and claims the benefit of priority of the prior Japanese Patent Application No. 2014-058949, filed on Mar. 20, 2014, the entire contents of which are incorporated herein by reference.

### FIELD

The embodiments discussed herein are related to a link-device selecting apparatus, a link-device selecting method, and a link-device selecting program.

### BACKGROUND

Attention has been paid to a technique for controlling, in a linked manner, a plurality of gadgets corresponding to a network and, in particular, a technique for performing such control according to the positions and postures of a device and user (a person who is using the device).

A device manager may manage a device controlling program for controlling a device equipped in, for example, a finance-related store. An instruction that includes an identifier of the device is provided from a business application to a device manager, and the device manager assigns the instruction to the device controlling program. An information processing apparatus is known wherein, when first and second devices are present, pieces of position information of the individual devices are associated with each other and are stored as connection-target management information, position information of an operator is detected, and an instruction is transmitted to the device having position information indicating a closer position.

A management system for information input-output apparatuses such as personal computers is known that is used to prevent an apparatus distant from an operator from being selected in the selecting of an information input-output apparatus on a network. As such a management system, a system is known that detects a physical transfer of an apparatus and that, when a predetermined transfer distance is exceeded, changes a setting of position information and displays a setting change message.

A communication function controlling apparatus is known that, upon receipt of a control request from an external apparatus, performs integrated control of a plurality of network apparatuses and media apparatuses. As such a controlling apparatus, a controller is known wherein a destination of an operator and an apparatus equipped at the destination are registered in advance, and user information is identified at the destination of the user so as to communicate with the registered apparatus (e.g., Japanese Laid-open Patent Publication Nos. 2007-79921, 10-177533, and 9-114759).

In the case of the apparatuses above, position information of an operator is used, and devices are operated in a linked manner when it is determined that the operator is located at a predetermined position.

However, for example, in controlling the opening and closing of a door in accordance with only the position of an operator, depending on the operator or the direction of the opening/closing of the door, the door could possibly hit the operator while it is opening. Use of user position information alone leads to problems wherein it is difficult to automatically select a device that is to be linked to an operation of an operator (hereinafter referred to as a “link-target device”), e.g., a problem wherein devices having the same function are located at positions at the same distance from the operator.

### SUMMARY

According to one aspect of an embodiment, a link-device selecting apparatus includes an evaluation value calculating unit and a selecting unit. The evaluation value calculating unit calculates evaluation values of a plurality of second devices using first information, second information, and importance levels. First information is information on the position and orientation of an operator of the first device. Second information is information on the positions and orientations of the plurality of second devices. The importance levels include an importance level of the position of a second device and an importance level of the orientation of the second device, both given in accordance with a function of the second device. The selecting unit selects a device to be linked to the first device from the plurality of second devices using the evaluation values.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary presentation scene in which a link device is selected;

FIG. 2 illustrates an example of a person's walking scene in which a link device is selected;

FIG. 3 illustrates distances between apparatuses;

FIG. 4 illustrates a posture match level;

FIG. 5 illustrates exemplary functional blocks of a link-device selecting apparatus in accordance with an embodiment;

FIG. 6 illustrates an exemplary environment in which a plurality of devices are present;

FIG. 7 illustrates an example of the sensing of position and posture information of a person;

FIG. 8 illustrates an example of the sensing of position and posture information of a device;

FIG. 9 illustrates another example of the sensing of position and posture information of a device;

FIG. 10 illustrates an exemplary device list;

FIG. 11 illustrates an exemplary evaluation table;

FIG. 12 illustrates the selecting of a link-target deice candidate;

FIG. 13 illustrates an exemplary result of the selecting of a link-target device;

FIG. 14 illustrates an exemplary configuration of a link-device selecting apparatus;

FIG. 15 illustrates an exemplary process flow of a first advance preparation process;

FIG. 16 illustrates an exemplary process flow of a second advance preparation process; and

FIG. 17 illustrates an exemplary process flow of a link-device selecting process.

### DESCRIPTION OF EMBODIMENTS

With reference to the drawings, the following will describe a link-device selecting apparatus, link-device selecting method, and link-device selecting program in accordance with embodiments.

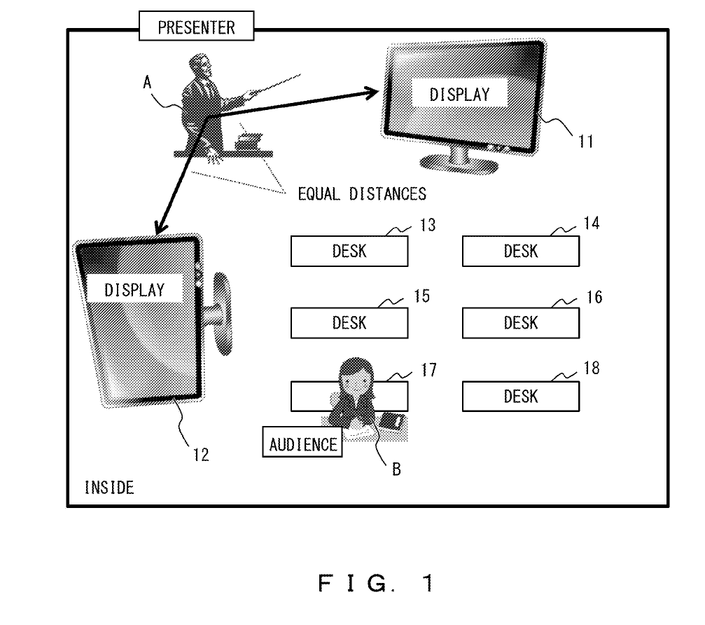

FIG. 1 illustrates an exemplary presentation scene in which a link device is selected. The environment depicted in FIG. 1 may be the inside of a room. Two displays 11 and 12 are located at positions at the same distance from a presenter A. Desks 13, 14, 15, 16, 17, and 18 to be used by audiences B are placed.

FIG. 1 is assumed to be illustrating a situation in which the operator (presenter A) starts a presentation while showing the screen of his smartphone (link-base device, i.e., device that establishes a link to another device on an as-needed basis) on the closer of the two displays 11 and 12. However, while the operator (presenter A) is standing at the midpoint between two displays within a room, it cannot be automatically determine in accordance with only the position of the operator which display (link-target device) is to be used.

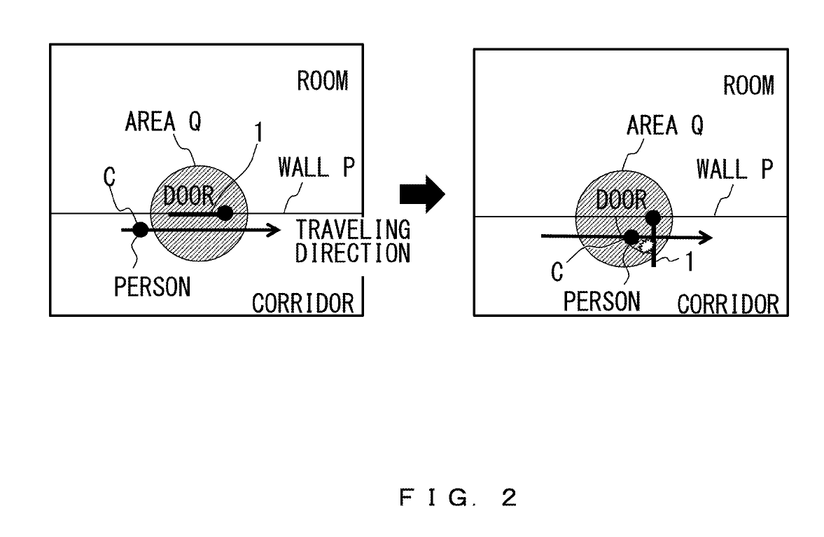

FIG. 2 illustrates an example of a person's walking scene in which a link device is selected. Referring to FIG. 2, a person C carries a smartphone (link-base device), a wall P separates a corridor from a room, and the wall is furnished with a door 19 (link-target device), i.e., the person can freely go back and forth between the corridor and the room. Assume that the door 19 is designed to open toward the corridor when the person C steps in an area Q surrounding the door 19. In such a case, when the person C enters the area Q while walking on the corridor along the wall P, the door 19 automatically opens and thus blocks the person C's path, as depicted in FIG. 2. That is, the opening of the door caused in association with a user being located in front of the room could lead to an accidental contact between the user and the door. In addition, a link to the door should not be established because a user cutting across in front of the room cannot be distinguished from an operator entering the room after turning around in front of the room by using position information alone.

As described above, in some scenes, it is difficult to automatically determine a device that should not be linked to a link device that uses position information alone.

Attention is paid to only a link between an operator and one device, and hence, in some cases, a device to be linked to cannot be automatically determined in a complicated case where a device to be used is selected in accordance with relationships between a plurality of users and a plurality of devices.

Accordingly, the following advantages can be achieved.

Descriptions will be given of a link-device selecting apparatus, link-device selecting method, and link-device selecting program capable of:
(T1) using posture information to automatically select a link device that cannot be determined according to only position information of an operator; and
(T2) automatically selecting a link device according to an evaluation value that is set in accordance with information on the relative positions and postures between a plurality of operators and a plurality of devices. Such a link-device selecting apparatus, link-device selecting method, and link-device selecting program may have the advantages that
(E1) a link-target device that cannot be determined according to only position information of an operator can be automatically selected, and
(E2) in a case where an operator is linked to a plurality of devices, even when, for example, a link device cannot be selected in accordance with only the distances between the operator and two devices, a link-target device can be automatically selected according to information on the positions and postures (orientations) of the operator and link-base device.

The definitions of terms are as follows.

An “operator” may be a person who operates one or more devices. In the presentation scene depicted in FIG. 1, the presenter A may be an operator. In the person's walking scene depicted in FIG. 2, the walker C may be an operator. One or more operators may be present.

A “user” may be a person who is not an operator and enjoys an advantage of one or more devices. In the presentation scene depicted in FIG. 1, the audience B may be a user. One or more users may be present.

A “link-base device” may be a device that makes a request for another device to be linked thereto. In the presentation scene depicted in FIG. 1, the smartphone carried by the presenter A may be a link-base device. In the person's walking scene depicted in FIG. 2, the smartphone held by the walker C maybe a link-base device. In the scenes illustrated in FIGS. 1 and 2, the link-base device is a general-purpose information device such as a smartphone. However, the link-base device may be a device for exclusive use.

A “link-target device” may be operated at a request from a link-base device. In the presentation scene depicted in FIG. 1, the displays 11 and 12 may be link-target devices. In the person's walking scene depicted in FIG. 2, the door 19 maybe a link-target device. Lists of “link-base devices” and “link-target devices” may be written to a file such as a device list together with functions of the devices, or may be stored in a database.

A “distance” may be a linear distance between a link-target-device candidate and a link-base device, user, or operator.

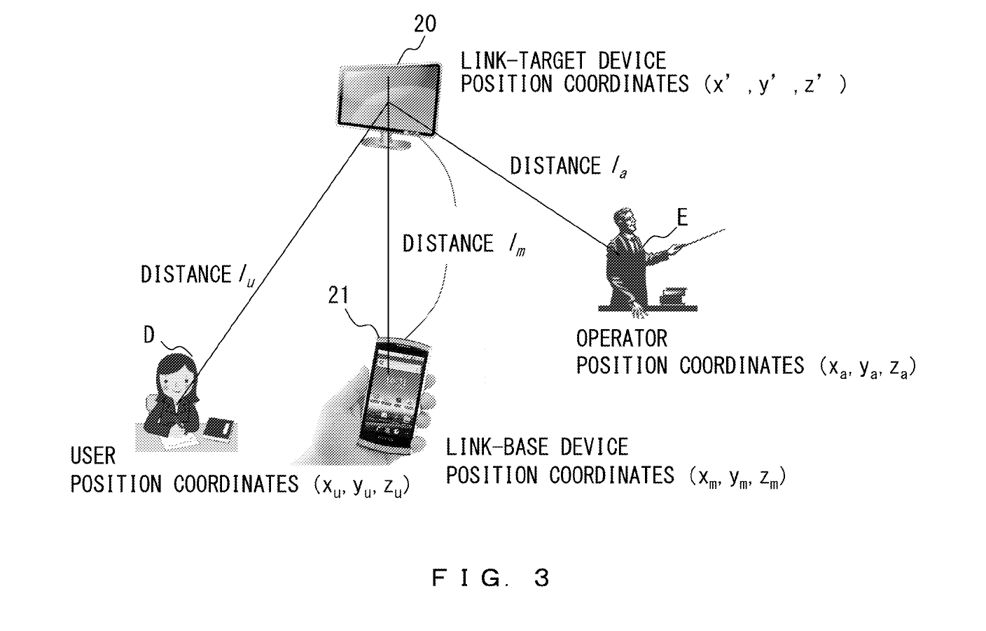

FIG. 3 illustrates distances.

FIG. 3 depicts a situation in which an operator E is located at position coordinates (xₐ, yₐ, zₐ) ; a link-base device 21, position coordinates (x_{m, y}_{m, z}ₘ); a link-target device 20, position coordinates (x′, y′, z′); and a user D, position coordinates (xᵤ, yᵤ, zᵤ).

According to the definitions above, a distance lₐ between the operator E and the link-target device 20 is

lₐ=\sqrt{(xₐ−x′)²+(yₐ−y′)²+(zₐ−z′)²}.

A distance lₘ between the link-base device 21 and the link-target device 20 is

lₘ=\sqrt{(xₘ−x′)²+(yₘ−y′)²+(zₘ−z′)²}.

A distance lᵤ between the user D and the link-target device 20 is

lᵤ=\sqrt{(xᵤ−x′)²+(yᵤ−y′)²+(zᵤ−z′)²}.

In regard to “posture”, the posture of the operator E or the user D may be the orientation of the line of sight, or may be the orientation of the front of the body. The posture may simply be referred to as an “orientation”. When the link-target device 20 or the link-base device 21 includes an output device having directivity, e.g., a display or speaker, the posture thereof may be the orientation of the directivity. In the case of, for example, a display, the normal direction of a screen may be a posture (orientation) .

An “evaluation value” may be determined using all or some of a distance, a posture match level, and importance levels for the distance and the posture match level. For example, a longer distance may lead to a lower evaluation value. In accordance with a function of a device, the evaluation value may monotonically increase or decrease in proportion to closeness.

A “posture match level” may be an angle formed by the front direction of a link-base device (or the front direction of the user's or operator's body) and a linear line from a link-target-device candidate to the link-base device, user, or operator, or may be an angle formed by the front direction of the link-target device and a linear line from the link-target-device candidate to the link-base device, user, or operator.

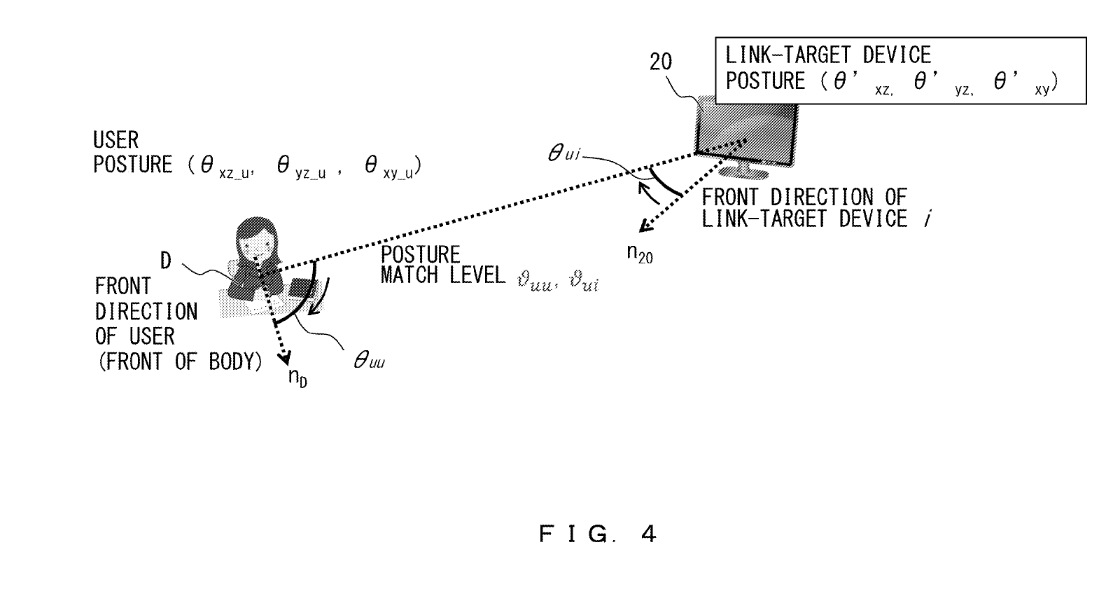

FIG. 4 illustrates a posture match level.

In the situation depicted in FIG. 4, θᵤᵤ indicates an angle formed by the front direction n_{D} of the user D and a linear line from the user D to the link-target device 20. θᵤᵢ indicates an angle formed by the front direction n₂₀ of the link-target device 20 and a linear line from the user D to the link-target device 20. A user posture is (θ_{xz}_{_{—}}ᵤ, θ_{yz}_{_{—}}ᵤ, θ_{xy}_{_{—}}ᵤ), and a link-target-device posture is (θ′_{xz}, θ′^{yz}, θ′_{xy}). The posture match level of the user D relative to the link-target device 20 is defined as θᵤᵤ and the posture match level of the link-target device 20 relative to the user D is defined as θᵤᵢ. The posture match levels θᵤᵢ and θᵤᵢ may be expressed as an angle equal to or less than 180°, or may be expressed as an angle of positive (+) when the linear line is inclined in a counterclockwise direction (θᵤᵤ in FIG. 4) and as an angle of negative (−) when the linear line is inclined in a clockwise direction (θᵤᵢ in FIG. 4).

θₘₘ, θᵤᵤ, or θₐₐ generally indicates an angle formed by a line segment from the link-base device, user, or operator to a link-target-device candidate and a half line extending in the front direction of the link-base device or the front direction of the user's body or the operator's body. θₘᵢ, θᵤᵢ, or θₐᵢ indicates an angle formed by a line segment extending from the link-base device, user, or operator and a half line extending in the front direction of a link-target device. The six angles, θₘₘ, θᵤᵤ, θₐₐ, θₘᵢ, θᵤᵢ, and θₐᵢ, will hereinafter be referred to as “posture match level”.

An evaluation value based on a posture match level may be expressed using an evaluation function maximized at, for example, |θₘₘ|+|θ_{mi|=0}, and a state in which the link-base device and a link-target device face each other maybe judged to be a state suitable to establish a link. Alternatively, the evaluation value may be expressed using a function maximized at |θᵤᵤ−θᵤᵢ|=π[rad], and a state in which the user and a link-target device face the same direction may be judged to be a state suitable to establish a link.

Importance levels for distance and posture match level may be determined in advance, written to a file such as an evaluation table, and stored in a database.

The “evaluation value” is obtained by assigning a current distance l and posture match level e, both based on the arrangement of the operator, user, link-base device, and link-target device, to an evaluation function formula fᵢ.

Let f indicate the evaluation formula; i, a link-target candidate device; u, a user; n, the total number of users; a, an operator; m, the number of link-base devices; lᵤᵢ, . . . , lᵤₘ, distances between a user and link-base devices; lₘ, the distance between a link-target candidate device and a link-base device; lₐ, the distance between an operator and a link-target candidate device; θᵤᵤₗ, . . . , θᵤᵤₘ, θₘₘ, θₘᵢ, θₐₐ, and θₐᵢ, posture match levels; α_{i,l} and α_{i,θ}, importance levels for the distance and posture match level relative to a link-target candidate device. In this case, the evaluation formula f may be expressed as follows:

$${f}_{i} = {α}_{i , l} ( \frac{1}{n} ( \frac{1}{{l}_{u 1} + 1} + \frac{1}{{l}_{u 2} + 1} + … + \frac{1}{{l}_{un} + 1} ) + \frac{1}{{l}_{m} + 1} + \frac{1}{{l}_{a} + 1} ) \times {α}_{i , θ} ( \frac{1}{n} ( \frac{1}{\vert {θ}_{uu 1} \vert + \vert {θ}_{ui 1} \vert + 1} + \frac{1}{\vert {θ}_{uu 2} \vert + \vert {θ}_{ui 2} \vert + 1} + … + \frac{1}{\vert {θ}_{uun} \vert + \vert {θ}_{uin} \vert + 1} ) + \frac{1}{π - \vert {θ}_{mm} - {θ}_{mi} \vert + 1} + \frac{1}{π - \vert {θ}_{aa} - {θ}_{ai} \vert + 1} )$$

Of course, the evaluation formula may be expressed in a different manner.

When a plurality of operators or users are present, some or all of a representative value, an average value, and data on all of the operators or users maybe used in a technique for using the distances or posture match levels of the operators or users as arguments of the evaluation formula.

The “importance level” may be the influence that, according to a function of a used device, a distance and/or a posture match level exert on calculation of an evaluation value in a case where a check list is created that is related to, for example, the presence/absence of a screen display function, sound reproduction function, and illumination function of the used device. An importance level a for the distance and an importance level _{θ}for the posture match level may satisfy the following formula:

αₗ+α_{θ}=1

The “evaluation value” is calculated by assigning a distance and posture match level obtained from the current positions and postures of an operator, user, link-base device, and link-target-device candidate and importance levels for the distance and the posture match level to the evaluation formula. A device candidate with the highest evaluation value or a device with an evaluation value equal to or higher than a threshold may be selected from all of the candidates as a link-target device.

### <Link-Device Selecting Apparatus>

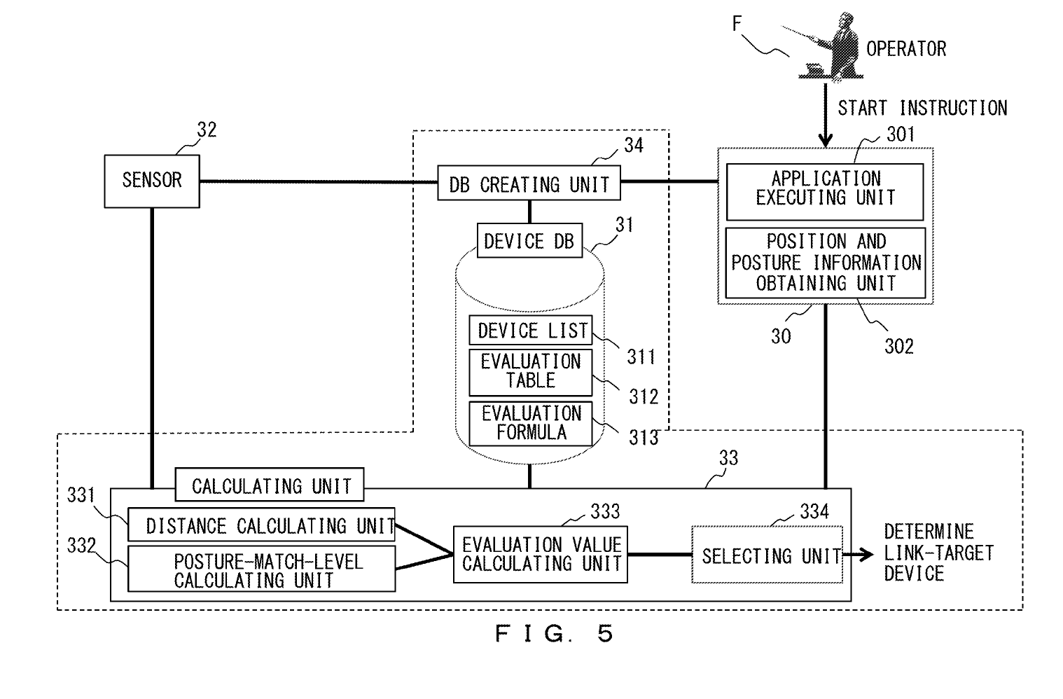

With reference to FIGS. 5-14, the following will describe a link-device selecting apparatus in accordance with embodiments.

As depicted in FIG. 5, an information device 30 operated by an operator F, e.g., a smartphone, an image-pickup apparatus, e.g., a camera, an information device, a sensor 32 installed in, for example, a smartphone (smartphone held by a user), a device database (DB) 31, a calculating unit 33, and a database (DB) creating unit 34 are present.

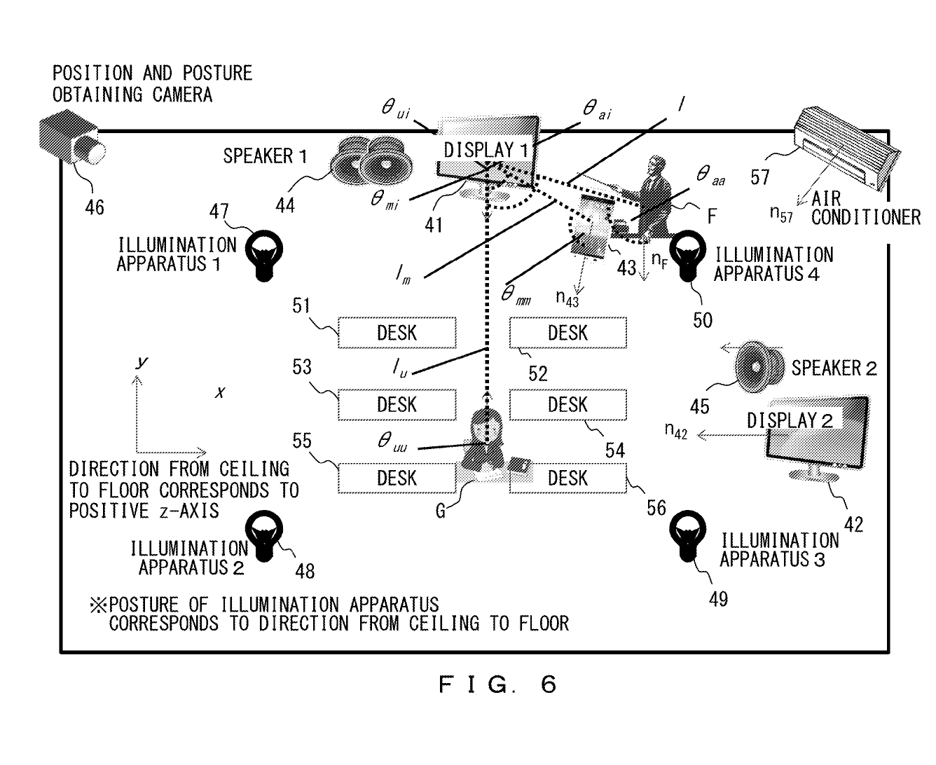

FIG. 6 illustrates an exemplary environment in which a plurality of devices are present.

In the example depicted in FIG. 6, an operator F holding a smartphone (information device) 43, i.e., a link-base device, and a user G hearing a presentation made by the operator are in a room. Two displays 1(41) and 2(42), two speakers 1(44) and 2(45), a camera 46, and four illumination apparatuses 1(47), 2(48), 3(49), and 4(50) are provided in the room in which the operator F and the user G stay. The postures of the illuminating apparatuses, installed to the ceiling, are such that the illuminating apparatuses face the floor. Orthogonal coordinates (x, y, z) with a z axis extending in a vertical direction are defined as position coordinates of the inside of the room. Rotational components (θ_{xz}, θ_{yz}, θ_{xy}) within planes xz, yz, and xy of the orthogonal coordinates may be set as posture coordinates.

FIG. 6 depicts only one operator, but adaptation to a plurality of operators is readily achieved. For a situation in which link-base devices corresponding to a plurality of operators select the same link-target device, the order of priority may be determined to select the operators in order starting from the operator with the highest priority.

The camera 46 may be used to obtain a position and a posture. Such devices may function as link-target devices operated in response to an instruction from the smartphone 43, i.e., a link-base device for assist in the presentation made by the operator F. Desks 51, 52, 53, 54, 55, and 56 and an air conditioner 57, all unrelated to the presentation, are also present. In such an environment, the operator F may make a presentation by showing an image stored in the smartphone 43 on a large screen, e.g., the display 1(41) or 2(42).

The link-device selecting apparatus automatically selects devices for use in the presentation. The devices may include the smartphone 43, the display 1(41), the display 2(42), the speaker 1(44), the speaker 2(45), the camera 46, the four illuminating apparatuses, i.e., the illuminating apparatuses 1(47), 2(48), 3(49), and 4(50), and the air conditioner 57.

The position coordinates of the operator F may be (xₐ, yₐ, zₐ) , and the posture of the operator F may be (θ_{xz}_{_{—}}ₐ, θ_{yz}_{_{—}}ₐ, θ_{xy}_{_{—}}ₐ) , where the xy plane corresponds to the floor of the room, and the position direction of the z axis corresponds to a direction from the ceiling to the floor. The position coordinates of the information device 30 operated by the operator F, e.g., a smart phone, may be (xₘ, yₘ, zₘ) , and the posture thereof may be (θ_{xz m}, θ_{yz m}, θ_{xy m}). The position coordinates of the display 1(41) may be (x′, y′, z′), and the posture thereof may be (θ′_{xz}, θ′_{yz}, θ′_{xy}). The position of the user G may be (xᵤ, yᵤ, zᵤ), and the posture thereof may be (θ_{xz u}, θ_{yz}_{_{—}}ᵤ, θ_{xy}_{_{—}}ᵤ).

An acceleration sensor, gyro sensor, or geomagnetic sensor installed in a camera or device provided within the room may be used to sense the positions and postures of the operator F and the user G and the positions and postures of devices such as the displays 1(41) and 2(42). The operator F may be identified using a device identifier (device ID) of, for example, the smartphone (information device) 43. The user G may carry an information device such as a smartphone so that the user G can be identified using a device ID.

The environment-installation camera 46, i.e., a camera for obtaining a position and a posture, uses an AR marker attached to a device so as to recognize the position and posture of a device such as the display 1(41) or 2(42), and outputs, to a distance calculating unit 311 and posture-match-level calculating unit 332 of the calculating unit 33, information for determining the position of the operator F or user G or the orientation of the body using a musculoskeletal model. The distance calculating unit 311 and posture-match-level calculating unit 332 of the calculating unit 33 may use an image captured by the environment-installation camera 46 so as to determine the position and posture of a device such as the display 1 (41) or 2 (42), the position of the operator F or user G, and the orientation of the body.

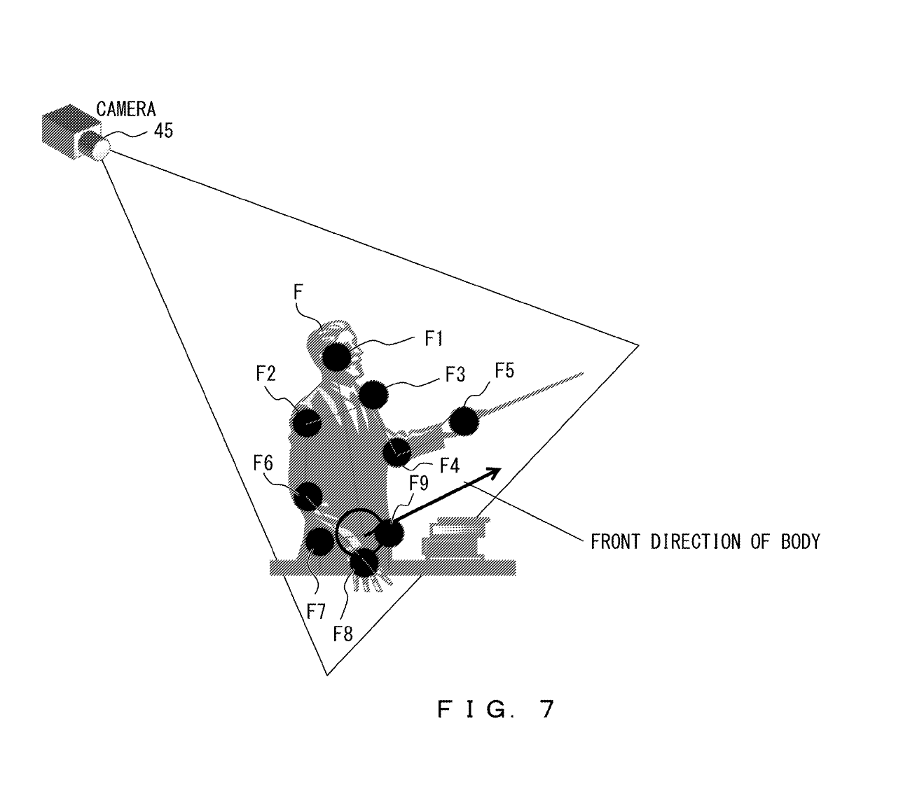

FIG. 7 illustrates an example of the sensing of position and posture information of a person.

In the example depicted in FIG. 7, the distance calculating unit 311 and posture-match-level calculating unit 332 of the calculating unit 33 may extract, from an image captured by the environment-installation camera 46, the positions of joints of head F1, shoulders F2 and F3, elbows F4 and F6, hands F5 and F8, hips F7 and F9, and so on of the operator F, apply a human musculoskeletal model obtained by linking these joints, and define an orientation vertical to a linear line at the lumbar part as the front of the body, thereby obtaining a posture (θ_{xz}_{_{—}}ₐ, θ_{yz}_{_{—}}ₐ, θ_{xy}_{_{—}}ₐ).

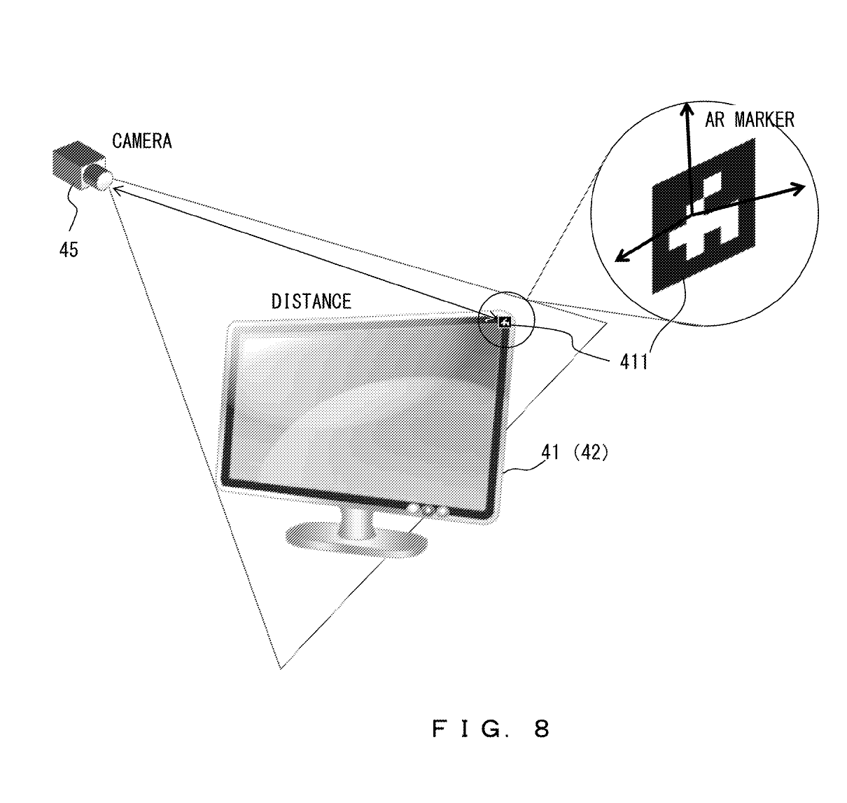

FIG. 8 illustrates an example of the sensing of position and posture information of a device.

In the example depicted in FIG. 8, the database (DB) creating unit 34 has a device such as the display 1(41) or 2(42) with an AR maker attached thereto. The camera 46 recognizes the AR marker to output information for determining the distance to the device such as the display 1(41) or 2(42) and the posture of the AR marker to the device DB 31. The database (DB) creating unit 34 obtains marker-based orthogonal coordinates from the angle of the AR marker captured by the camera. The database (DB) creating unit 34 may obtain the distance between the camera and the AR marker and the postures thereof in accordance with the visibility of the image of the AR marker attached to the device, i.e., an image captured by the camera. The database (DB) creating unit 34 may obtain AR-marker-attachment coordinates (x, y, z) as the position coordinates of the device and may obtain a front-direction-based device posture θ_{xz}, θ_{yz} , θ_{xy}) from the difference in orientation between the orthogonal coordinates of the AR marker and the orthogonal coordinates of the room.

As described above, the camera 46 or another element may function as the sensor 32 depicted in FIG. 5.

To obtain a position and a posture according to an AR marker, the database (DB) creating unit 34 may use, for example, QPToolkit ®.

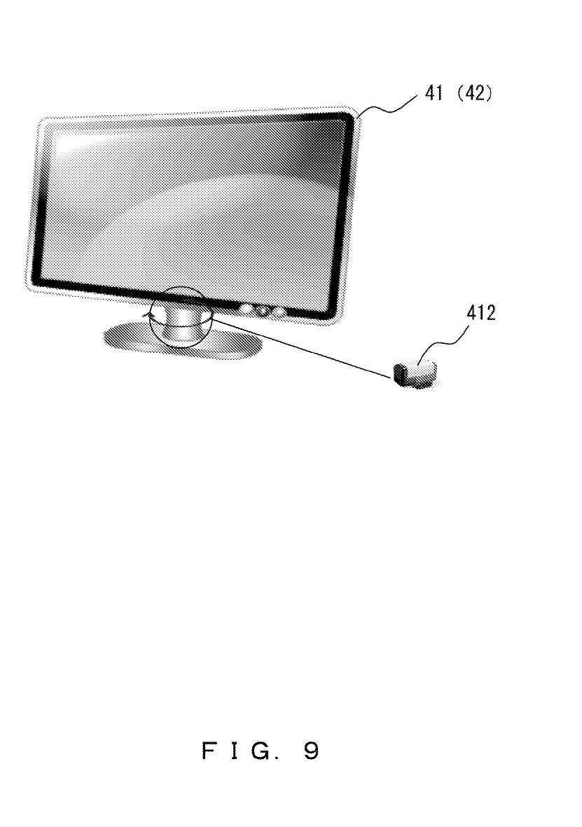

FIG. 9 illustrates another example of the sensing of position and posture information of a device.

In the example depicted in FIG. 9, a device such as the display 1(41) or 2(42) has installed therein a sensor 412, e.g., a gyro sensor, acceleration sensor, or geomagnetic sensor. The sensor 412 may measure the rotation of the device. The database (DB) creating unit 34 may obtain the front-direction-based device posture (θ_{xz} , θ_{yz}, θ_{xy}) using a measurement result provided by the sensor 412.

In a case where the device is fixed within the room and thus does not change the posture, the database (DB) creating unit 34 may continuously use the position and posture information of the device established when the device was installed in the room.

The operator F and the user G may be identified by recognizing the device IDs of smartphones they carry.

The device database (DB) 31, the calculating unit 33, and the database (DB) creating unit 34 may be combined to form a link-device selecting apparatus. However, the device database (DB) 31 and the database (DB) creating unit 34 may be external apparatuses, and the calculating unit 33 alone may form the link-device selecting apparatus. The following descriptions are based on a condition in which the link-device selecting apparatus includes the device database (DB) 31, the calculating unit 33, and the database (DB) creating unit 34.

The information device 30 operated by the operator F includes an application executing unit 301 and a position and posture information extracting unit 302. The operator F may input a start instruction to the information device 30. The information device 30 is operated as a link-base device.

The application executing unit 301 executes an application that causes a link-target device to perform a predetermined operation. For example, the application maybe an application for causing a display to display an image, or maybe an application for causing a speaker to reproduce sounds. Alternatively, the application may be an application for operating a nearby movable body (e.g., a door).

The position and posture information extracting unit 302 extracts the position and posture of the information device 30. The position and posture information extracting unit 302 may include an image pickup apparatus such as a camera, and an analyzing unit that extracts the position and posture of the information device 30 from an image obtained by the image pickup apparatus, or may include a sensor capable of simultaneously detecting a position and a posture.

The device database (DB) 31 is created by the database (DB) creating unit 34, and may store a device list 311, an evaluation table 312, and an evaluation formula 313. The database (DB) creating unit 34 may create, for example, the device list 311 and the evaluation table 312 according to information obtained by the sensor 32 and may store these lists in the device database (DB) 31. The database (DB) creating unit 34 may create the evaluation formula 313 through learning based on, for example, data on a past event. Alternatively, the evaluation formula 313 may be input from outside, or a formula input via the information device 30 may be stored as the evaluation formula 313 in the device database (DB) 31.

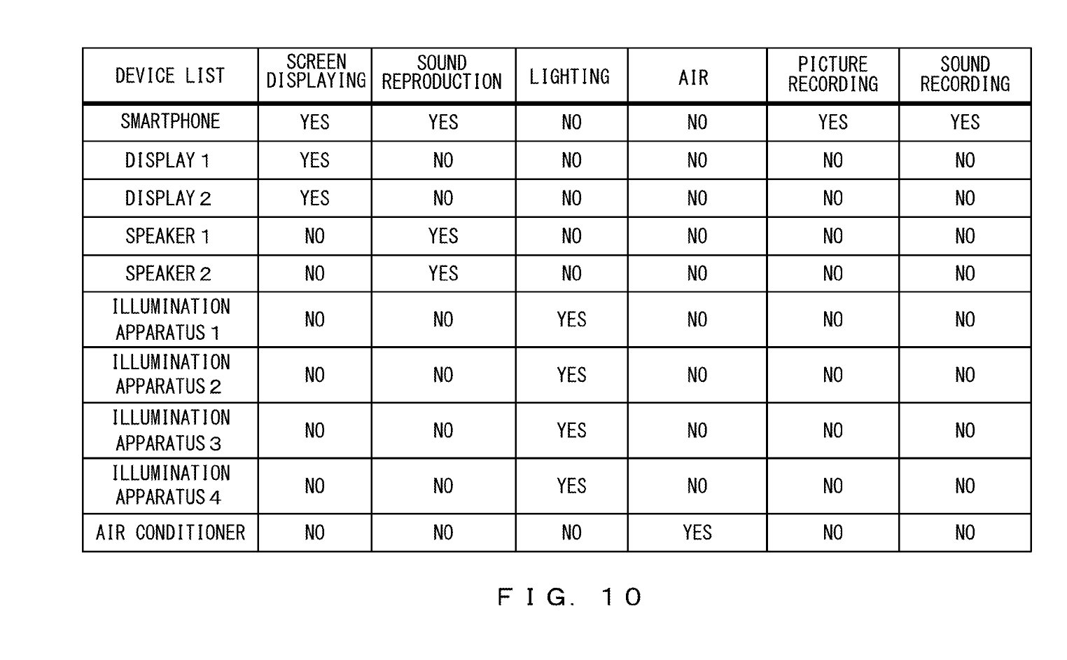

FIG. 10 illustrates an example of the device list 311.

The device list 311 depicted in FIG. 10 describes the presence/absence of the smartphone 43, the display 1(41), the display 2(42), the speaker 1(44), the speaker 2(45), the camera 46, the four illumination apparatuses 1(47), 2(48), 3(49), and 4(50), and the air conditioner 57. Although FIG. 10 depicts “IMAGE DISPLAY”, “SOUND REPRODUCTION”, “LIGHTING”, “AIR CONDITIONING”, “PICTURE RECORDING”, and “SOUND RECORDING” as functions, not all of these functions need to be included, and another function maybe included. The device list 311 may be used when the database (DB) creating unit 34 calculates a distance importance level αₗ or posture-match-level importance level α_{θ} for each device.

The device list 311 may be obtained by listing all devices within a room for each function in an advance preparation for device linking. For each individual function, the device list 311 may indicate a check result as to whether the devices have the function. For example, the device list 311 may be manually created in advance. Device identification information such as device IDs may be incorporated into the devices so that the device list 311 can be automatically updated over a network.

The evaluation table 312 describes a distance importance level α and a posture-match-level importance level a for each device function.

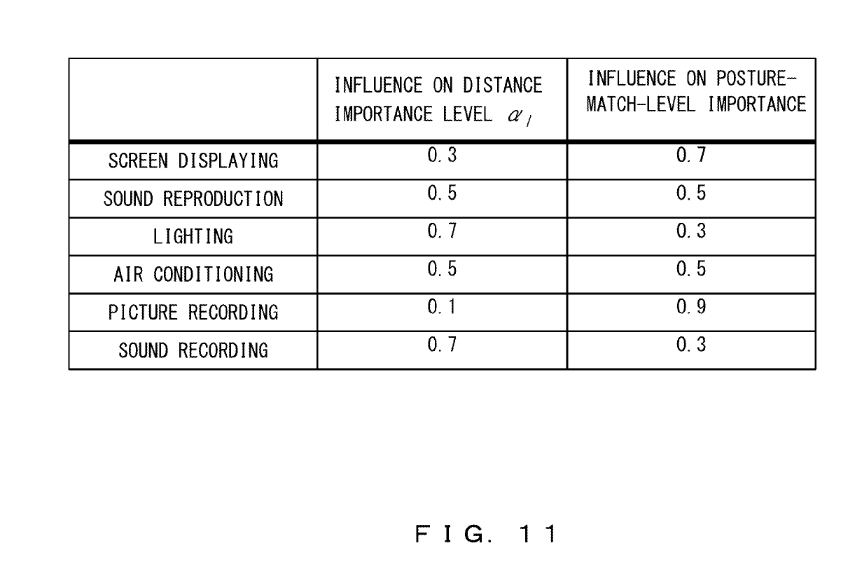

FIG. 11 illustrates an exemplary evaluation table.

The database (DB) creating unit 34 causes the evaluation table 312 depicted in FIG. 11 to describe “INFLUENCE ON DISTANCE IMPORTANCE LEVEL αₗ” and “INFLUENCE ON POSTURE-MATCH-LEVEL IMPORTANCE LEVEL α_{θ}” for individual functions of “SCREEN DISPLAYING”, “SOUND REPRODUCTION”, “LIGHTING”, “AIR CONDITIONING”, “PICTURE RECORDING”, and “IMAGE RECORDING”. “INFLUENCE ON DISTANCE IMPORTANCE LEVEL αₗ” and “INFLUENCE ON POSTURE-MATCH-LEVEL IMPORTANCE LEVEL α₀” may be referred to as the level of influence relative to a position and the level of influence relative to an orientation, respectively. Alternatively, these may be collectively simply called influence levels. In one possible example, for the function “SCREEN DISPLAYING”, a weight of 0.7 is assigned to the influence on distance importance level αₗ, and a weight of 0.3 is assigned to the influence on posture-match-level importance level α_{θ}. The sum of “INFLUENCE ON DISTANCE IMPORTANCE LEVEL αₗ” and “INFLUENCE ON POSTURE-MATCH-LEVEL IMPORTANCE LEVEL α_{θ}” may be set to 1.0. After randomly setting the importance levels αₗ and α_{θ}, the database (DB) creating unit 34 may learn optimum values through machine learning, or may create values using a preset evaluation function.

The database (DB) creating unit 34 refers to the evaluation table 312 so as to calculate a distance importance level αₗ and a posture-match-level importance level α_{θ} for each device.

In one possible example, the database (DB) creating unit 34 calculates a distance importance level αₗ for the smartphone 43 using the following formula.

$${α}_{l} = \frac{\begin{matrix}0.3 ( screen displaying ) + 0.5 ( sound reproduction ) + \\ 0.1 ( picture recording ) + 0.7 ( image recording )\end{matrix}}{4 ( \begin{matrix}total number of items {}_{}^{``}{YES}{}_{}^{″} \\ for {}_{}^{``}{SMARTPHONE}{}_{}^{″} in device list\end{matrix} )} = 0.4$$

The database (DB) creating unit 34 calculates a posture-match-level importance level α_{θ} for the smartphone 43 using the following formula.

$${α}_{θ} = \frac{\begin{matrix}0.7 ( screen displaying ) + 0.5 ( sound reproduction ) + \\ 0.9 ( picture recording ) + 0.3 ( image recording )\end{matrix}}{4 ( \begin{matrix}total number of items {}_{}^{``}{YES}{}_{}^{″} \\ for {}_{}^{``}{SMARTPHONE}{}_{}^{″} in device list\end{matrix} )} = 0.6$$

That is, the importance level a may be an average weight of contribution of a function of the device within the device list to an importance level.

Similarly, an evaluation value calculating unit 333 of the calculating unit 33 calculates αₗ=0.3 as a distance importance level αₗ for the displays 1(41) and 2(42), and α_{θ}=0.7 as a posture-match-level importance level α_{θ} therefor. The evaluation value calculating unit 333 of the calculating unit 33 calculates αₗ=0.5 as a distance importance level αₗ for the speakers 1(44) and 2(45), and α_{θ}=0.5 as a posture-match-level importance level α_{θ} therefor. The evaluation value calculating unit 333 of the calculating unit 33 calculates αₗ=0.5 as a distance importance level αₗ for the speakers 1(44) and 2(45), and α_{θ}=0.5 as a posture-match-level importance level α_{θ}therefor. The evaluation value calculating unit 333 of the calculating unit 33 calculates αₗ=0.5 as a distance importance level αₗ for the air conditioner 57, and α_{θ}=0.5 as a posture-match-level importance level α_{θ} therefor.

Subsequently, the database (DB) creating unit 34 manually extracts a function needed in an application executed by the smartphone 43 (e.g., an application for support in a presentation), or automatically extracts such a function from information incorporated into a device. The database (DB) creating unit 34 groups devices listed in the device list 311 as link-target candidates for each needed function. A designer creates an evaluation formula for each group in consideration of a desirable position and posture for use of each function.

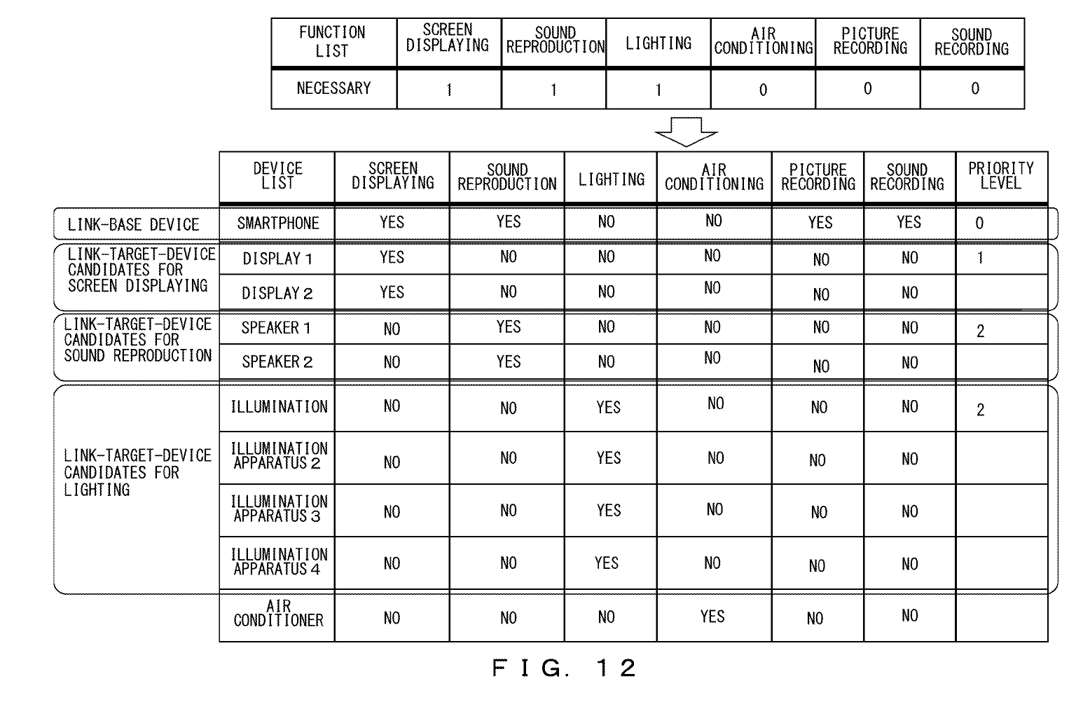

FIG. 12 illustrates selecting a link-target deice candidate.

In the example depicted in FIG. 12, in the application executing unit 301 of the smartphone 30 depicted in FIG. 5, a link-target device needs the functions “SCREEN DISPLAYING”, “SOUND REPRODUCTION”, and “LIGHTING”. The needed functions may be manually set by the operator F, or may be automatically set by an application. In any case, needed functions are listed in accordance with an application for a presentation.

The evaluation value calculating unit 333 of the calculating unit 33 creates a selection evaluation formula f from device candidates, as link-target devices, having the functions of screen displaying, sound reproduction, and lighting for each of the functions of screen displaying, sound reproduction, and lighting. In one possible example, in FIG. 12, the evaluation value calculating unit 333 of the calculating unit 33 extracts the displays 1(41) and 2(42) as devices having a needed function “SCREEN DISPLAYING”, and groups together these devices as “LINK-TARGET DEVICE CANDIDATE FOR SCREEN DISPLAYING”. In FIG. 12, the evaluation value calculating unit 333 of the calculating unit 33 extracts the speakers 1(44) and 2(45) as devices having a needed function “SOUND REPRODUCTION”, and groups together these devices as “LINK-TARGET DEVICE CANDIDATE FOR SOUND REPRODUCTION”. In FIG. 12, the evaluation value calculating unit 333 of the calculating unit 33 also extracts the illumination apparatuses 1(47), 2(48), 3(49), and 4(50) as devices having a needed function “LIGHTING”, and groups together these devices as “LINK-TARGET DEVICE CANDIDATE FOR LIGHTING”.

A priority level may be assigned to each group. A link-base device may have a priority level of 0, and a link-target device may have a priority level of 1 or greater. Higher priority may be given to a device with a priority level of a lower value. Priority levels may, of course, be set in any manner. In the example of FIG. 12, the priority level of the screen displaying function is 1, and the priority levels of the sound reproduction function and the lighting function are 2.

After an evaluation function is initially given, a value in the function may be automatically updated to an optimum value using a technique such as machine learning. An order in which link-target devices are determined in the executing of an application may be determined by assigning a priority level to each group. Link-target devices are determined starting from the device with a priority level of the lowest value, and, in the determining of a link-target device with a priority level n, a link-target device determined at a priority level (n-1) is used as a link-base device.

The evaluation value calculating unit 333 of the calculating unit 33 refers to the evaluation formula 313 from the device DB 31 so as to calculate an evaluation value for each device.

As the distance from a link-target display to both an operator and a user becomes shorter, screen display is easily viewable. Descriptions can be more simply given of a situation in which a display and a user face each other, and the display faces a direction that is identical with a direction in which the operator faces while giving a presentation. In consideration of these facts, the database (DB) creating unit 34 may set in advance an evaluation formula related to the screen displaying function.

For example, the database (DB) creating unit 34 may set a desirable position and posture for use of each function, and, in accordance with the setting, may create an evaluation formula using a distance, a posture match level, and an importance level.

The evaluation formula f may be expressed as indicated below, where i indicates a link-target candidate device; u, a user; n, the total number of users; a, an operator; m, a link-base device; lᵤₗ, . . . , lᵤₘ, lₘ, and lₐ, distances; θᵤᵤₗ, . . . , θᵤᵤₘ, θₘₘ, θₙᵢ, θₐₐ, and θₐᵢ posture-match levels; α_{i,l} and α_{i,θ}, importance levels of distances and posture match levels.

$${f}_{i} = {α}_{i , l} ( \frac{1}{n} ( \frac{1}{{l}_{u 1} + 1} + \frac{1}{{l}_{u 2} + 1} + … + \frac{1}{{l}_{un} + 1} ) + \frac{1}{{l}_{m} + 1} + \frac{1}{{l}_{a} + 1} ) \times {α}_{i , θ} ( \frac{1}{n} ( \frac{1}{\vert {θ}_{uu 1} \vert + \vert {θ}_{ui 1} \vert + 1} + \frac{1}{\vert {θ}_{uu 2} \vert + \vert {θ}_{ui 2} \vert + 1} + … + \frac{1}{\vert {θ}_{uun} \vert + \vert {θ}_{uin} \vert + 1} ) + \frac{1}{π - \vert {θ}_{mm} - {θ}_{mi} \vert + 1} + \frac{1}{π - \vert {θ}_{aa} - {θ}_{ai} \vert + 1} )$$

In the example depicted in FIG. 6, one user, i.e., a user G, is present, but, when a plurality of users are present, an evaluation formula may be set such that a representative value or average value of the distances and posture-match levels of the users are used, or may be set such that data on all of the users is used. These processes maybe performed in advance as advance preparation processes before the operator F inputs a command to the smartphone 43.

When the operator F actually starts a presentation, the application executing unit 301 selects, in accordance with an application to be executed, a group of link-target-device candidates for which position and posture information is to be obtained. The position and posture information obtaining unit 302 obtains, via the sensor 32, real-time position and posture information of the link-target-device candidates, the operator F, the user G, and a link-base device such as the smartphone 43. A distance calculating unit 331 calculates distances 1 to the operator F, the user G, a link-base device such as the smartphone 43, and link-target-device candidates such as the display 1(41) the display 2(42) the speaker 1(44), and the speaker 2(45). The posture-match-level calculating unit 332 calculates posture match levels θ. In addition, the evaluation value calculating unit 333 substitutes the calculated values in an evaluation formula together with importance levels α of the link-target-device candidates, thereby calculating evaluation values.

Assume that, in the situation depicted in FIG. 6, the positions and postures of the user G, the operator F, the smartphone (link-base device) 43, and the display 1 (link-target device) (41), and the display 2 (link-target device) (42) are as follows. That is, the position coordinates of the user G are (x=10, y=10, z=0) , and the posture is (θ_{xz}_{_{—}}ᵤ=0, θ_{yz}_{_{—}}ᵤ=0, θ_{xy}_{_{—}}ᵤ=3π/2); the position coordinates of the operator Fare (x=7, y=7, z=0), and the posture is (θ_{xz}_{_{—}}ᵤ=0, θ_{yz}_{_{—}}ᵤ=0, θ_{xy}_{_{—}}ᵤ=π/2); the position coordinates of the smartphone (link-base device) 43 are (x=10, y=10, z=0), and the posture is (θ_{xz}_{_{—}}ᵤ=0, θ_{yz}_{_{—}}ᵤ=0, θ_{xy}_{_{—}}ᵤ=3π/2); the position coordinates of the display 1 (link-target device) (41) are (x′=7, y′=12, z′=0), and the posture is (θ′_{xz}=0, θ′_{yz}=0, θ′_{xy}=3π/2); and the position coordinates of the display 2 (link-target device) (42) are (x″=12, y″=7, z″=0), and the posture is (θ″_{xz}=0, θ″_{yz}=0, θ″_{xy}=π)

The following will simply describe which of the display 1(41) or the display 2(42) is to be selected as a link-target device from among the devices indicated in “LINK-TARGET-DEVICE CANDIDATES FOR SCREEN DISPLAYING” depicted in FIG. 12.

The database (DB) creating unit 34 may calculate a distance importance level αₗ and posture-match-level importance level α_{θ} for each of the displays 1(41) and 2(42), and distance importance level αₗ=0.3 and posture-match-level importance level α_{θ}=0.7 may be satisfied.

Using the values above, the evaluation value calculating unit 333 of the calculating unit 33 calculates evaluation values f_{display1} and f_{display2} for the display 1 (link-target device) (41) and the display 2 (link-target device) (42). For example, the evaluation values f_{display1} and f_{display2} for the display 1 (link-target device) (41) and the display 2 (link-target device) (42) may be calculated as follows.

$$\begin{matrix}{f}_{display 1} = {α}_{i , l} ( \frac{1}{n} ( \frac{1}{{l}_{u 1} + 1} + \frac{1}{{l}_{u 2} + 1} + … + \frac{1}{{l}_{un} + 1} ) + \frac{1}{{l}_{m} + 1} + \frac{1}{{l}_{a} + 1} ) \times \\ {α}_{i , θ} ( \frac{1}{n} ( \begin{matrix}\frac{1}{\vert {θ}_{uu 1} \vert + \vert {θ}_{ui 1} \vert + 1} + \frac{1}{\vert {θ}_{uu 2} \vert + \vert {θ}_{ui 2} \vert + 1} + … + \\ \frac{1}{\vert {θ}_{uun} \vert + \vert {θ}_{uin} \vert + 1}\end{matrix} ) + \\ \frac{1}{π - \vert {θ}_{mm} - {θ}_{mi} \vert + 1} + \frac{1}{π - \vert {θ}_{aa} - {θ}_{ai} \vert + 1} ) \\ = 0.3 \times ( \frac{1}{5 + 1} + \frac{1}{\sqrt{13} + 1} + \frac{1}{\sqrt{13} + 1} ) \times \\ 0.7 \times ( \frac{1}{0 + 1} + \frac{1}{π - π + 1} + \frac{1}{π - π + 1} ) \\ = 0.379\end{matrix}$$

$$\begin{matrix}{f}_{display 2} = {α}_{i , l} ( \frac{1}{n} ( \frac{1}{{l}_{u 1} + 1} + \frac{1}{{l}_{u 2} + 1} + … + \frac{1}{{l}_{un} + 1} ) + \frac{1}{{l}_{m} + 1} + \frac{1}{{l}_{a} + 1} ) \times \\ {α}_{i , θ} ( \frac{1}{n} ( \begin{matrix}\frac{1}{\vert {θ}_{uu 1} \vert + \vert {θ}_{ui 1} \vert + 1} + \frac{1}{\vert {θ}_{uu 2} \vert + \vert {θ}_{ui 2} \vert + 1} + … + \\ \frac{1}{\vert {θ}_{uun} \vert + \vert {θ}_{uin} \vert + 1}\end{matrix} ) + \\ \frac{1}{π - \vert {θ}_{mm} - {θ}_{mi} \vert + 1} + \frac{1}{π - \vert {θ}_{aa} - {θ}_{ai} \vert + 1} ) \\ = 0.3 \times ( \frac{1}{5 + 1} + \frac{1}{\sqrt{13} + 1} + \frac{1}{\sqrt{13} + 1} ) \times \\ 0.7 \times ( \frac{1}{π / 2 + 1} + \frac{1}{π - π / 2 + 1} + \frac{1}{π - π / 2 + 1} ) \\ = 0.241\end{matrix}$$

Consequently, the display 1, which has the higher evaluation value, may be selected as a link-target device.

According to evaluation values obtained in a similar way, the evaluation value calculating unit 333 of the calculating unit 33 selects the speaker 1(44) or 2(45) as a link-target device from among the devices indicated in “LINK-TARGET-DEVICE CANDIDATES FOR SOUND REPRODUCTION” depicted in FIG. 12, and selects the illumination apparatus 1(47), 2(48), 3(49), or 4(50) as a link-target device from among the devices indicated in “LINK-TARGET-DEVICE CANDIDATES FOR LIGHTING” depicted in FIG. 12.

A selecting unit 334 of the calculating unit 33 refers to the evaluation values so as to make a determination to select a link-target device.

When f_{dislplay1}>f_{display2} as in the case of the example above, the display 1 is selected as a link-target device and is output.

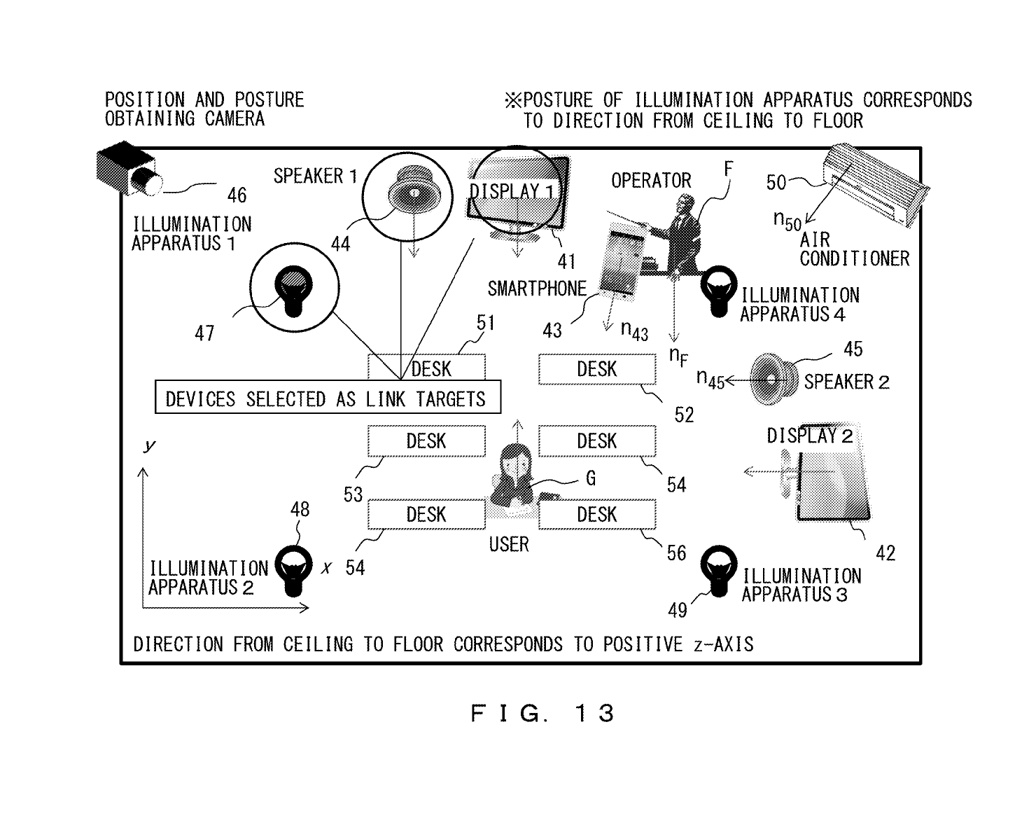

FIG. 13 illustrates an exemplary result of the selecting of a link-target device.

As in the case of selecting the display 1 as a link-target device, for a sound-reproduction-oriented or lighting-oriented link-target device with a priority level of 2, the evaluation value calculating unit 333 of the calculating unit 33 sets the display 1, i.e., a screen displaying function with a priority level of 1, as a link-base device, and calculates an evaluation value. Using the calculation result, the selecting unit 334 of the calculating unit 33 selects the speaker 1 and the illumination apparatus 2 as link-target devices; the speaker 1 reproduces sounds, and the illumination apparatus 2 is turned off.

As described above, the link-device selecting apparatus includes the evaluation value calculating unit 333 and the selecting unit 334.

The evaluation value calculating unit 333 may calculate evaluation values of a plurality of second devices (link-target devices) 41, 42, 44, 45, 47, 48, 49, 50, and 57 using first information related to the position and orientation of the operator (operator F) of the first device (link-base device) 30 or 43, second information related to the positions and orientations of the plurality of second devices (link-target devices) 41, 42, 44, 45, 47, 48, 49, 50, and 57, and the importance levels of the positions and orientations of the plurality of second devices (link-target devices) 41, 42, 44, 45, 47, 48, 49, 50, and 57, the importance levels being assigned in accordance with functions of the second devices 41, 42, 44, 45, 47, 48, 49, 50, and 57.

Using the evaluation values, the selecting unit 334 may select a device to be linked to the first devices 30 and 43 from the plurality of second devices 41, 42, 44, 45, 47, 48, 49, 50, and 57.

The link-device selecting apparatus may further include the posture-match-level calculating unit 332.

The posture-match-level calculating unit 332 may calculate first posture match levels obtained from angles formed by the orientations of the second devices 41, 42, 44, 45, 47, 48, 49, 50, and 57 with the orientations of the first devices 30 and 43, and may calculate second posture match levels obtained from angles formed by the orientations of the second devices 41, 42, 44, 45, 47, 48, 49, 50, and 57 with the orientation of the operator (operator F). In this case, the evaluation value calculating unit 333 may calculate the evaluation value using at least one of first and second distances.

The link-device selecting apparatus may further include the distance calculating unit 331.

The distance calculating unit 331 may calculate at least one type of distances from among first distances from the second devices 41, 42, 44, 45, 47, 48, 49, 50, and 57 to the first devices 30 and 43 and second distances from the second devices 41, 42, 44, 45, 47, 48, 49, 50, and 57 to the operator (operator F). The evaluation value calculating unit 333 may calculate an evaluation value using at least one of the first distance or the second distance.

The evaluation value calculating unit 333 of the link-device selecting apparatus may further calculate evaluation values of the second devices 41, 42, 44, 45, 47, 48, 49, 50, and 57 using at least one of third information related to the positions and orientations of the first devices 30 and 43 or fourth information related to the position and orientation of the user G of the second devices 41, 42, 44, 45, 47, 48, 49, 50, and 57.

The link-device selecting apparatus may further include the posture-match-level calculating unit 332, which calculates third posture match levels obtained from angles formed by the orientations of the second devices 41, 42, 44, 45, 47, 48, 49, 50, and 57 with the orientation of the user G. The evaluation value calculating unit 333 may calculate an evaluation value using the third posture match level.

The evaluation value calculating unit 333 may select the second devices 41, 42, 44, 45, 47, 48, 49, 50, and 57 in accordance with a function needed to execute an application implemented in the first devices 30 and 43, and may calculate evaluation values of the selected second devices 41, 42, 44, 45, 47, 48, 49, 50, and 57.

In addition, using priority levels assigned to individual functions needed to execute an application, the selecting unit 334 may select the second devices 41, 42, 44, 45, 47, 48, 49, 50, and 57 to be linked to the first devices 30 and 43.

Using the aforementioned configuration, the link-device selecting apparatus achieves the advantages of:
(T1) using posture information to automatically select a link device that cannot be determined only using position information of the operator;
(T2) automatically selecting a link device according to evaluation values determined using information on mutual positions and postures between a plurality of operators and a plurality of devices;
(E1) automatically selecting a link-target device that cannot be determined only using position information of an operator; and
(E2) in a scene where an operator establishes a link to a plurality of devices, e.g., a situation in which a link device cannot be selected using only distances between the operator and two devices, automatically selecting a link-target device using information on the positions and postures of the operator and a link-base device.

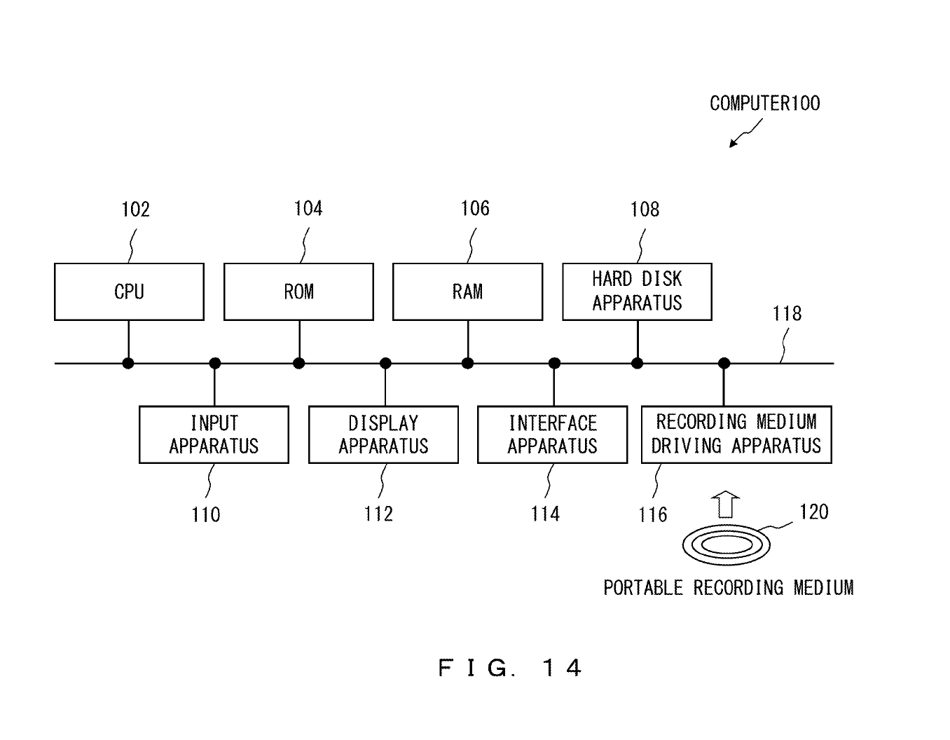

FIG. 14 illustrates an exemplary configuration of a link-device selecting apparatus.

A computer 100 includes a Central Processing Unit (CPU) 102, a Read Only Memory (ROM) 104, and a Random Access Memory (RAM) 106. The computer 100 further includes a hard disk apparatus 108, an input apparatus 110, a display apparatus 112, an interface apparatus 114, and a recording medium driving apparatus 116. These elements are connected to each other by a bus line 118 and may exchange various types of data with each other under the management of the CPU 102.

The Central Processing Unit (CPU) 102 is a processor for controlling operations of the entirety of the computer 100, and functions as a control processing unit of the computer 100.

The Read Only Memory (ROM) 104 is a read-only semiconductor memory in which a predetermined basic control program is recorded in advance. The CPU 102 reads and executes the basic control program during starting of the computer 100 so that operations of elements of the computer 100 can be controlled.

The Random Access Memory (RAM) 106 is a semiconductor memory used as a work storage space as appropriate when the CPU 102 executes various control programs. Data can be written to, and can be read from, the Random Access Memory (RAM) 106 on an as-needed basis.

The hard disk apparatus 108 is a storage apparatus that stores various control programs to be executed by the CPU 102 and various types of data. The CPU 102 may read and execute a predetermined control program stored in the hard disk apparatus 108 so as to perform various control processes that will be described hereinafter.

The input apparatus 110 is, for example, a mouse apparatus or keyboard apparatus. When a user of an information processing apparatus operates the input apparatus 110, the input apparatus 110 obtains an input of various types of information associated with the operation, and transmits the input information to the CPU 102.

The display apparatus 112 is, for example, a liquid crystal display, and displays various texts and images in accordance with display data transmitted from the CPU 102.

The interface apparatus 114 manages exchange of various types of information with various devices connected to the computer 100.

The recording medium driving apparatus 116 reads various control programs and data recorded in a portable recording medium 120. The CPU 102 may read a predetermined control program from the portable recording medium 120 via the recording medium driving apparatus 116, and may execute the program so as to perform various control processes that will be described hereinafter. The portable recording medium 120 may be a non-transitory computer-readable recording medium, e.g., a flash memory provided with a USB (Universal Serial Bus)-standard connector, a CD-ROM (Compact Disc Read Only Memory), or a DVD-ROM (Digital Versatile Disc Read Only Memory).

In one possible example, to configure a link-device selecting apparatus using the computer 100, a control program (link-device selecting program) is created for causing the CPU 102 to perform processes that would be performed by the aforementioned processing units. The created control program is stored in the hard disk apparatus 108 or the portable recording medium 120 in advance. A predetermined instruction is given to the CPU 102, and the CPU 102 reads and executes the control program (link-device selecting program) . In this way, the CPU 102 provides functions of the link-device selecting apparatus.

### <Link-Device Selecting Process>

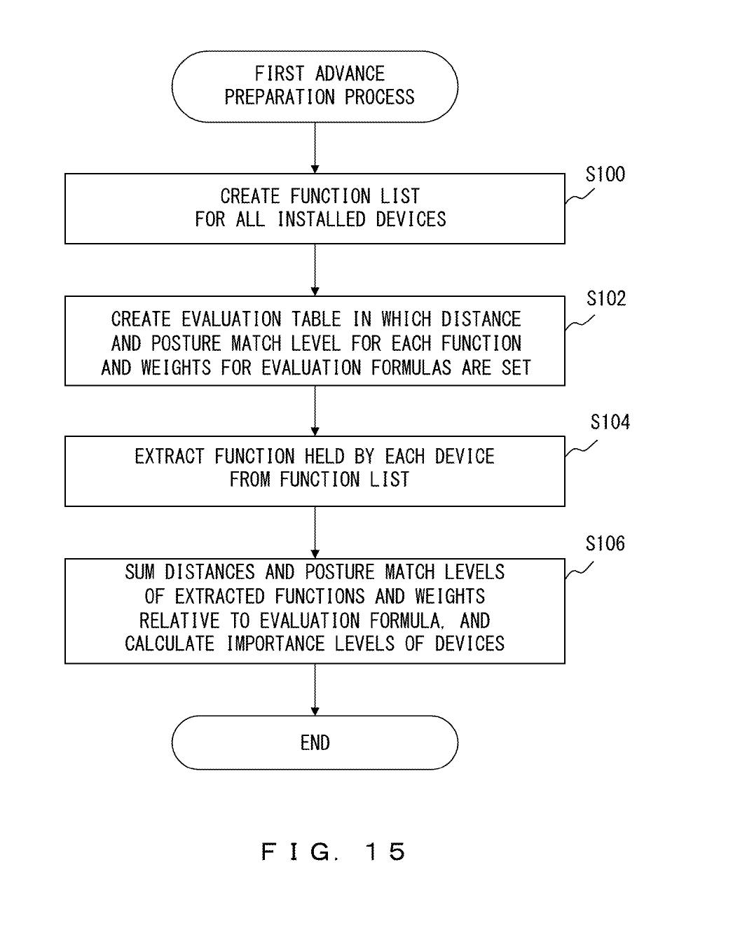

The following will describe the flow of a link-device selecting process with reference to FIGS. 15-17.

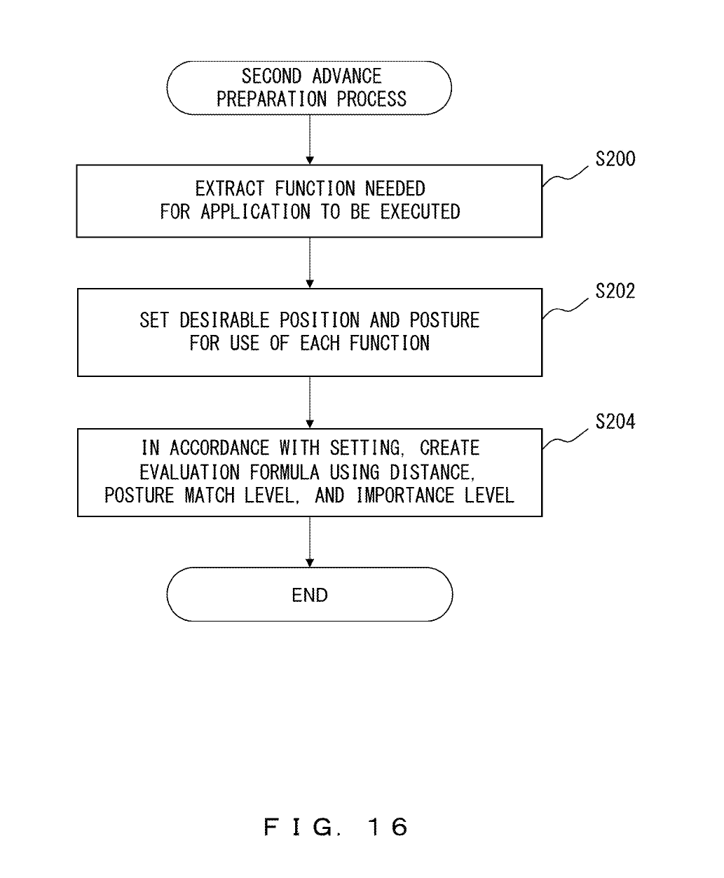

FIG. 15 illustrates an exemplary process flow of a first advance preparation process. FIG. 16 illustrates an exemplary process flow of a second advance preparation process.

In a case where the link-device selecting apparatus is the computer 100, i.e., a general-purpose computer such as that depicted in FIG. 14, the following descriptions define a control program (link-device selecting program) that performs such a process. That is, in the following, descriptions will be given of a control program (link-device selecting program) that causes a general-purpose computer to perform the processes described in the following.

The first and second advance preparation processes may be performed before the operator of the link-device selecting apparatus inputs data to the apparatus.

When the first advance preparation process starts, in S100, the database (DB) creating unit 34 uses, for example, information obtained by the sensor 32 so as to create a device list of all installed devices, and stores the device list in the device database (DB) 31 as the device list 311. FIG. 10 illustrates an exemplary device list. In this step, for example, only the item “DEVICE LIST” of the device list depicted in FIG. 10 may be created. When the process of this step ends, the flow shifts to S102.

In S102, the database (DB) creating unit 34 creates an evaluation table in which a distance and posture match level for each function and weights for evaluation formulae are set, and stores the evaluation table in the evaluation table 312 of the device database (DB) 31. FIG. 11 illustrates an exemplary evaluation table. When the process of this step ends, the flow shifts to S104.

In S104, the application executing unit 301 of the smartphone 30 extracts a function held by each device from the device list 311. In this step, for each device in the device list depicted in FIG. 10, functions held by each device, e.g., “SCREEN DISPLAYING”, “SOUND REPRODUCTION”, “LIGHTING”, “AIR CONDITIONING”, “PICTURE RECORDING”, and “SOUND RECORDING”, may be specified. When the process of this step ends, the flow shifts to S106.

In S106, the database (DB) creating unit 34 sums distance and posture match levels of extracted functions and weights relative to an evaluation formula, and calculates importance levels of the devices.

For example, the database (DB) creating unit 34 may calculate a distance importance level αₗ for the smartphone 43 and a posture-match-level importance level α_{θ} for the smartphone 43 using the following formulae.

$${α}_{l} = \frac{\begin{matrix}0.3 ( screen displaying ) + 0.5 ( sound reproduction ) + \\ 0.1 ( picture recording ) + 0.7 ( image recording )\end{matrix}}{4 ( \begin{matrix}total number of items {}_{}^{``}{YES}{}_{}^{″} \\ for {}_{}^{``}{SMARTPHONE}{}_{}^{″} in device list\end{matrix} )} = 0.4$$

$${α}_{θ} = \frac{\begin{matrix}0.7 ( screen displaying ) + 0.5 ( sound reproduction ) + \\ 0.9 ( picture recording ) + 0.3 ( image recording )\end{matrix}}{4 ( \begin{matrix}total number of items {}_{}^{``}{YES}{}_{}^{″} \\ for {}_{}^{``}{SMARTPHONE}{}_{}^{″} in device list\end{matrix} )} = 0.6$$

When the process of this step ends, the first advance preparation process ends.

When the second advance preparation process starts, in S200, according to information from the application executing unit 301 of the smartphone 30, the database (DB) creating unit 34 extracts a function needed for an application to be executed. In FIG. 12, the three functions “IMAGE DISPLAYING”, “SOUND REPRODUCTION”, and “LIGHTING” are extracted as functions needed for an application. When the process of this step ends, the flow shifts to S202.

In S202, the database (DB) creating unit 34 sets a desirable position and posture for use of each function. When the process of this step ends, the flow shifts to S204.

In S204, in accordance with the position and posture set in S202, the database (DB) creating unit 34 creates an evaluation formula using a distance, a posture match level, and an importance level. When the process of this step ends, the second advance preparation process ends.

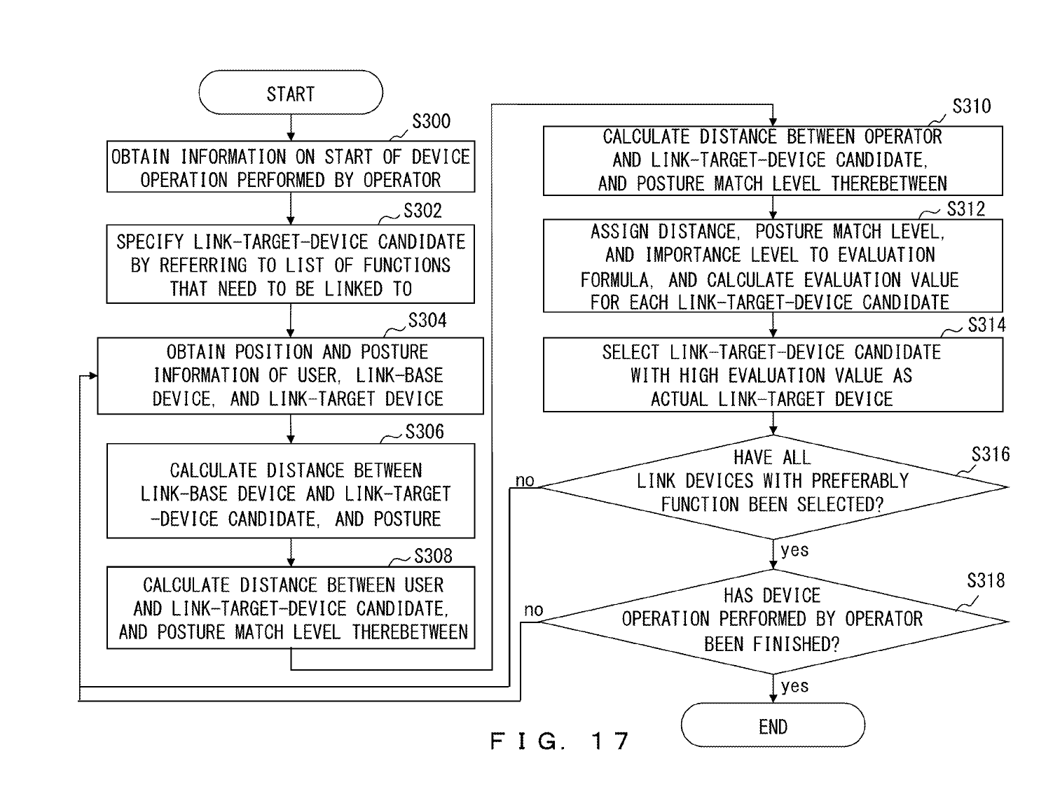

FIG. 17 illustrates an exemplary process flow of a link-device selecting process.

When the process starts, the application executing unit 301 of the smartphone 30 obtains in S300 information on start of a device operation performed by an operator F. For example, information on input from the user (operator) F for activating a specific application may be obtained. When the process of this step ends, the flow shifts to S302.

In S302, the evaluation value calculating unit 333 of the calculating unit 33 specifies a link-target-device candidate by referring to a list of functions that need to be linked to. In the example depicted in FIG. 12, the application executing unit 301 of the smartphone 30 in FIG. 5 requires that a link-target device have the functions “SCREEN DISPLAYING”, “SOUND REPRODUCTION”, and “LIGHTING”. In FIG. 12, the evaluation value calculating unit 333 of the calculating unit 33 extracts the displays 1(41) and 2(42) as devices having one preferably function “SCREEN DISPLAYING”, and groups these devices together as “LINK-TARGET-DEVICE CANDIDATES FOR SCREEN DISPLAYING”. In FIG. 12, the evaluation value calculating unit 333 of the calculating unit 33 also extracts the speakers 1(44) and 2(45) as devices having one preferably function “SOUND REPRODUCTION”, and groups these devices together as “LINK-TARGET-DEVICE CANDIDATES FOR SOUND REPRODUCTION”. In FIG. 12, the evaluation value calculating unit 333 of the calculating unit 33 also extracts the illumination apparatuses 1(47), 2(48), 3(49), and 4(50) as devices having one preferably function “LIGHTING”, and groups these devices together as “LINK-TARGET-DEVICE CANDIDATES FOR LIGHTING”.

In S304, the distance calculating unit 331 and the posture-match-level calculating unit 332 obtain position and posture information obtained by the sensor 32 and the position and posture information obtaining unit 302 of the smartphone 30(43), i.e., position and posture information of the user (operator), link-base device (e.g., the smartphone 30), and link-target devices (e.g., the displays 1(41) and 2(42), the speakers 1(44) and 2(45), the camera 46, the four illumination apparatuses 1(47), 2(48), 3(49), and 4(50), and the air conditioner 57). When the process of this step ends, the flow shifts to S306.

In S306, the distance calculating unit 331 and the posture-match-level calculating unit 332 calculate a distance between a link-base device and a link-target-device candidate, and a posture match level therebetween. In the example of FIG. 6, a distance between the smartphone 43 and the display 1(41) and a posture match level therebetween are calculated. When the process of this step ends, the flow shifts to S308.

In S308, the distance calculating unit 331 and the posture-match-level calculating unit 332 calculate a distance between a user G and a link-target-device candidate, and a posture match level therebetween. In the example of FIG. 6, a distance between the user G and the display 1(41) and a posture match level therebetween are calculated. When the process of this step ends, the flow shifts to S310.

In S310, the distance calculating unit 331 and the posture-match-level calculating unit 332 calculate a distance between the operator and a link-target-device candidate, and a posture match level therebetween. In the example of FIG. 6, a distance between the operator F and the display 1(41) and a posture match level therebetween are calculated. When the process of this step ends, the flow shifts to S312.

An order in which the processes of S306-S310 are performed is not limited to the order indicated by the example of FIG. 17. The processes of S306, S308, and S310 may be performed in any order.

In S312, the evaluation value calculating unit 333 assigns a distance, a posture match level, and an importance level to an evaluation value stored in the device DB 31 as the evaluation formula 313, and calculates an evaluation value for each link-target-device candidate.

The evaluation formula f may be

$${f}_{i} = {α}_{i , l} ( \frac{1}{n} ( \frac{1}{{l}_{u 1} + 1} + \frac{1}{{l}_{u 2} + 1} + … + \frac{1}{{l}_{un} + 1} ) + \frac{1}{{l}_{m} + 1} + \frac{1}{{l}_{a} + 1} ) \times {α}_{i , θ} ( \frac{1}{n} ( \frac{1}{\vert {θ}_{uu 1} \vert + \vert {θ}_{ui 1} \vert + 1} + \frac{1}{\vert {θ}_{uu 2} \vert + \vert {θ}_{ui 2} \vert + 1} + … + \frac{1}{\vert {θ}_{uun} \vert + \vert {θ}_{uin} \vert + 1} ) + \frac{1}{π - \vert {θ}_{mm} - {θ}_{mi} \vert + 1} + \frac{1}{π - \vert {θ}_{aa} - {θ}_{ai} \vert + 1} )$$

where i indicates a link-target candidate device; u, a user; n, the total number of users; a, an operator; m, a link-base device; lᵤₗ, . . . , lᵤₘ, lₘ, and lₐ distances; θᵤᵤₗ, . . . , θᵤᵤₘ, θₘₘ, θₘᵢ, θₐₐ, and θₐᵢ, posture-match levels; α_{i,l} and α_{i,θ}, importance levels of distances and posture match levels. When the process of this step ends, the flow shifts to S314.

In S314, the selecting unit 334 selects a link-target-device candidate with a high evaluation value as an actual link-target device. In the example depicted in FIG. 13, the display 1 is selected as a link-target device; for link-target devices with a priority level of 2 for sound reproduction and lighting, the selecting unit 334 of the calculating unit 33 selects the speaker 1 and the illumination apparatus 2 as link-target devices; the speaker 1 reproduces sounds, and the illumination apparatus 1 is turned off. When the process of this step ends, the flow shifts to S316.

In S316, the selecting unit 334 determines whether all link devices with a preferably function have been selected. When the result indicates a determination of “yes”, i.e., when all link devices with a preferably function have already been selected, the flow shifts to S318. When the result indicates a determination of “no”, i.e., when not every device with a preferably function has been selected, the flow returns to S304.

In S318, the application executing unit 301 determines whether a device operation performed by the operator F has been finished. When the result indicates a determination of “yes”, i.e., when the device operation performed by the operator F has been finished, the flow ends. When the result indicates a determination of “no”, i.e., when the device operation performed by the operator F has not been finished, the flow returns to S304.

Performing the aforementioned processes may provide the advantages that (T1) a link device that cannot be determined according to only position information of an operator is automatically selected using posture information; (T2) a link device can be automatically selected according to an evaluation value that is set in accordance with information on the relative positions and postures between a plurality of operators and a plurality of devices; (E1) a link-target device that cannot be determined according to only position information of an operator can be automatically selected; (E2) in a case where an operator is linked to a plurality of devices, even when, for example, a link device cannot be selected in accordance with only the distance between the operator and two devices, a link-target device can be automatically selected according to information on the positions and postures of the operator and link-base device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

What is claimed is:

1. A link-device selecting apparatus comprising:
an evaluation value calculating unit configured to calculate evaluation values of a plurality of second devices using first information related to a position and orientation of an operator of a first device, second information related to positions and orientations of the plurality of second devices, importance levels for the positions of the second devices, and importance levels for the orientations of the second devices, the importance levels for the positions and the importance levels for the orientations being assigned in accordance with a function of the second devices; and
a selecting unit configured to select a device to be linked to the first device from the plurality of second devices using the evaluation values.

2. The link-device selecting apparatus according to claim 1, further comprising:
a posture-match-level calculating unit configured to calculate a first posture match level obtained from an angle formed by the orientation of the second device and the orientation of the first device and a second posture match level obtained from an angle formed by the orientation of the second device and the orientation of the operator, wherein
the evaluation value calculating unit calculates the evaluation values using at least one of the first distance or the second distance.

3. The link-device selecting apparatus according to claim 1, further comprising:
a distance calculating unit configured to calculate at least one of a first distance between the second device and the first device or a second distance between the second device and the operator, wherein
the evaluation value calculating unit calculates the evaluation values using at least one of the first distance or the second distance.

4. The link-device selecting apparatus according to claim 1, wherein
the evaluation value calculating unit further calculates the evaluation values of the second devices using at least one of third information related to the position and orientation of the first device or fourth information related to a position and orientation of a user of the second devices.

5. The link-device selecting apparatus according to claim 4, further comprising:
a posture-match-level calculating unit configured to calculate a third posture match level obtained from an angle formed by the orientation of the second device and the orientation of the user, wherein
the evaluation value calculating unit calculates the evaluation values using the third posture match levels.

6. The link-device selecting apparatus according to claim 1, wherein
the evaluation value calculating unit selects any of the second devices in accordance with a function needed to execute an application implemented by the first device, and calculates an evaluation value of the selected second device.

7. The link-device selecting apparatus according to claim 1, wherein
using a priority level assigned to each of the functions needed to execute the application, the selecting unit further determines a second device to be linked to the first device.

8. A link-device selecting method processed by a processor, wherein
the processor performs the processes of
calculating evaluation values of a plurality of second devices using first information related to a position and orientation of an operator of a first device, second information related to positions and orientations of the plurality of second devices, importance levels for the positions of the second devices, and importance levels for the orientations of the second devices, the importance levels for the positions and the importance levels for the orientations being assigned in accordance with a function of the second devices, and
selecting a device to be linked to the first device from the plurality of second devices using the evaluation values.

9. A non-transitory computer-readable recording medium having stored therein a program for causing a processor to execute a link-device selecting process, the link-device selecting process comprising:
calculating evaluation values of a plurality of second devices using first information related to a position and orientation of an operator of a first device, second information related to positions and orientations of the plurality of second devices, importance levels for the positions of the second devices, and importance levels for the orientations of the second devices, the importance levels for the positions and the importance levels for the orientations being assigned in accordance with a function of the second devices; and
selecting a device to be linked to the first device from the plurality of second devices using the evaluation values.
